(19) United States
(12) Patent Application Publication
(10) Pub. No.: US 2005/0029869 A1
(43) Pub. Date: Feb. 10, 2005

(54) CONTROLLED VEHICLE SHUTDOWN SYSTEM

(75) Inventors: Roberto Teran, Jr., Livonia, MI (US); Kiana Danielle Whitehead, Romulus, MI (US); Thomas Joseph Stoltz, Allen Park, MI (US); Paul Michael Deniston, Westland, MI (US); Paul Szuszman, Ann Arbor, MI (US)

Correspondence Address: KEVIN G. MIERZWA;ARTZ & ARTZ, P.C., 28333 TELEGRAPH ROAD, SUITE 250, SOUTHFIELD, MI, 48034, US

(73) Assignee: FORD GLOBAL TECHNOLOGIES, LLC, Dearborn, MI (US)

(21) Appl. No.: 10/604,661

(22) Filed: Aug. 7, 2003

(51) Int. Cl. H02H 1/00

(52) U.S. Cl. 307/10.1

(57) ABSTRACT

A vehicle shutdown system (10) includes an ignition-enabling device (14) that has an ON state and an OFF state. A controller (18) that has multiple functions is coupled to the ignition-enabling device (14). The controller (18) temporarily maintains operation of the controller functions when the ignition-enabling device (14) is switched to the OFF state.

### BACKGROUND OF INVENTION

The present invention relates to drive-by-wire and electronic throttle control systems. More particularly, the present invention relates to a system and method of controlling shutdown of a vehicle.

Accelerator and brake foot pedal assemblies are commonly used to mechanically control a vehicle engine and brakes, respectively. The foot pedal assemblies usually include a pedal arm mounted to a vehicle body with a series of links and levers connecting the pedal arm to control an associated device. The links and levers may control a fuel injector, a throttle body, a brake drum, or the like. These assemblies must be designed to withstand and accommodate engine movements relative to the vehicle frame, as well as to provide accurate control despite such movements. In addition, the assemblies must be designed to operate within limited packaging space allotted for such devices.

Drive-by-wire systems have been introduced to overcome and satisfy the durability, operating accuracy, and space limitations requirements of the pedal assemblies. Drive-by-wire systems allow the control of the vehicle engine or brakes without the need for a direct mechanical connection between the pedal arms and the engine or the brakes. These systems utilize electrical or electronic means rather than mechanical links.

Several current electronic throttle control systems have a default position for the throttle plate. The default position is typically approximately 7-8° from a closed position, which allows a small amount of air to enter the engine. The default position serves as an availability feature in that when the electronic throttle is inoperable, the engine remains running at a high idle. The high idle allows the driver to operate the vehicle and proceed to a desired destination.

It is undesirable to allow the throttle plate to close completely upon switching “OFF” the vehicle ignition. When the throttle plate is closed or is in a 0° position a risk arises of exhaust gases reversing flow back into the engine. Exhaust gases can reverse flow into the engine due to low pressures that exist within the intake manifold of the engine. The low pressures are caused by the pumping action of the engine, as the engine is spinning down. The existence of the exhaust gases in the engine can cause a hard start when the ignition system is reactivated. Since exhaust gases, in general, have a significantly low combustibility level they can prevent the engine from starting. A hard start is negatively perceived by the vehicle operator and is therefore deemed undesirable.

Unfortunately, the default position also has an associated disadvantage that occurs during shutdown. Upon driver deactivation of the ignition system, since the throttle plate is in the default position and thus the engine is still receiving air, momentum of the engine can cause an increase in the amount of air being compressed. The increase in the amount of air being compressed can cause the engine to run inappropriately, resulting in engine noise and vibration. The noise and vibration can travel through the vehicle body to various vehicle components. A vehicle occupant may even feel the vibration through a seat or steering wheel of the vehicle. This noise and vibration is perceived as annoying and is therefore undesirable.

Thus, there exists a need for an improved method of operating an electronically controlled throttle that prevents the generation of noise and vibration when the ignition is disabled and that also allows for an equalization of the low pressure or vacuum that exists within an engine intake during engine shutdown. The improved method should not affect feel and performance of the electronic throttle pedal or of the electronic throttle control system.

### SUMMARY OF INVENTION

The present invention provides a vehicle shutdown system and method of powering down a vehicle. The vehicle shutdown system includes an ignition-enabling device that has an ON state and an OFF state. A controller, that has multiple functions, is coupled to the ignition-enabling device. The controller temporarily maintains operation of the controller functions when the ignition-enabling device is switched to the OFF state.

The embodiments of the present invention provide several advantages. One of several advantages provided by the present invention is the provision of a vehicle shutdown system that maintains power and functionality of the controller during shutdown of the vehicle, such as, for example, upon receiving a vehicle disablement signal. In so doing, the present invention allows the controller to perform multiple tasks after receiving the vehicle disablement signal.

Another advantage provided by one embodiment of the present invention is the provision of a throttle control system that allows a throttle-controlled device to be in a controlled position during idle vehicle operations and that minimizes noise and vibration during vehicle shutdown.

Furthermore, another advantage provided by an embodiment of the present invention is the provision of storing a position of the throttle-controlled device, of a crankshaft, and of a camshaft for improved vehicle start and operating performance.

Moreover, yet another advantage of an embodiment of the present invention is improved vehicle emissions, which is provided by reducing the amount of hydrocarbons produced and by decreasing the amount of evaporative emissions generated by a vehicle.

The present invention itself, together with attendant advantanges, will be best understood by reference to the following detailed description, taken in conjunction with the accompanying figures.

### BRIEF DESCRIPTION OF DRAWINGS

For a more complete understanding of this invention reference should now be made to embodiments illustrated in greater detail in the accompanying figures and described below by way of examples of the invention wherein:

FIG. 1 is a block diagrammatic view of a vehicle shutdown system in accordance with an embodiment of the present invention;

FIG. 2 is a schematic and block diagrammatic view of the vehicle shutdown system in accordance with an embodiment of the present invention; and

FIG. 3 is a logic flow diagram illustrating a power cycle for the vehicle shutdown system in accordance with an embodiment of the present invention.

### DETAILED DESCRIPTION

In the following figures the same reference numerals will be used to refer to the same components. While the present invention is described with respect to a system and method of powering down a vehicle, the present invention may be adapted and applied to various systems including: ignition systems, throttle control systems, vehicle control systems, drive-by-wire systems, or other systems known in the art where controlled shutdown and functional enablement therein is desired.

In the following description, various operating parameters and components are described for multiple constructed embodiments. These specific parameters and components are included as examples and are not meant to be limiting.

Also, in the following description the term “vehicle component” may refer to any component or system of components within a vehicle. For example, a vehicle component may refer to a stereo, an air-conditioning system, one or more lights, an ignition system, a lock, a seat system, an overhead console, or other various components or systems within a vehicle.

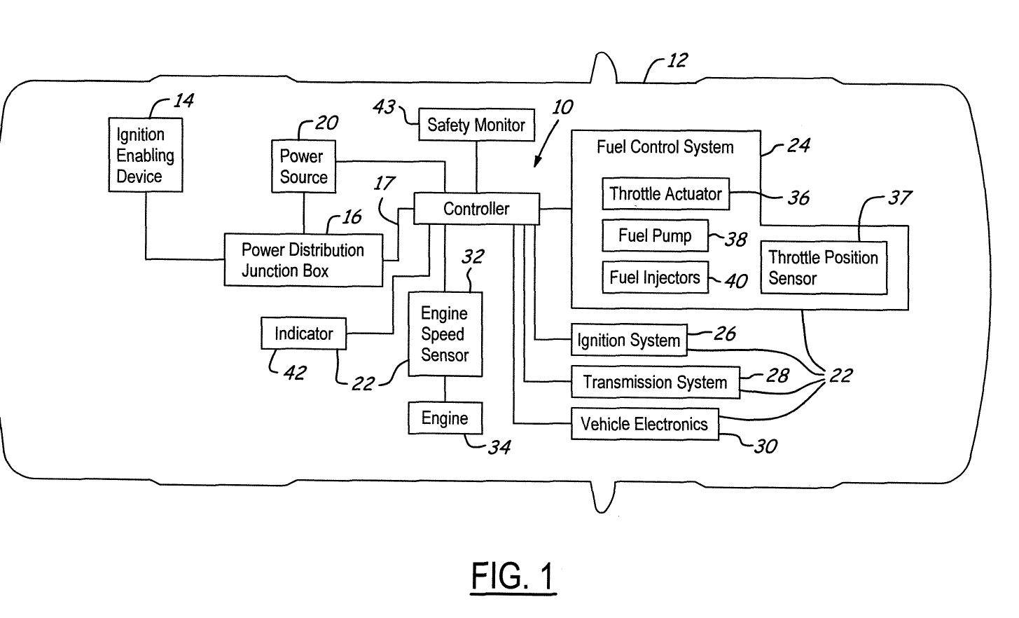

Referring now to FIG. 1, a block diagrammatic view of a vehicle shutdown system 10 for a vehicle 12 in accordance dance with an embodiment of the present invention is shown. The shutdown system 10 includes an ignition-enabling device 14 that is coupled to a power distribution junction box 16. The junction box has an output 17 that is coupled to a controller 18. The junction box 16 supplies power from a first power source 20 directly and indirectly to various vehicle components and systems 22. The vehicle components and systems 22 include a fuel control system 24, an ignition system 26, a transmission system 28, and vehicle electronics 30, as shown, as well as other components and systems known in the art. The vehicle components 22 include an engine speed sensor 32, which detects speed of an engine 34. The controller 18 during vehicle shutdown maintains operation of multiple controller functions until the speed, which may be in revolutions-per-minute, of the engine 34 is approximately equal to zero.

The ignition-enabling device 14 may be active or passive. The term “active ignition-enabling device” refers to a device that requires some sort of action by an operator in order to actuate a locking or starting mechanism. An example of an active system is one that uses a remote control to remotely access or start the vehicle 12, such a system may utilize a keyfob (not shown). A passive device, typically, includes an authorization device (also not shown), such as a smart card, which has a coded signal. When the authorization device is within a predetermined range of the vehicle 12, the controller 18 checks the coded signal on the authorization device before allowing access or ignition enablement of the vehicle 12. The ignition device 14 may be in the form of an ignition start key assembly, an ignition start, an ignition switch, or other ignition starting device known in the art.

The junction box 16 may supply power to any number of components or systems. The junction box 16 may include fuses, relays, switches, splitters, and other power distribution components known in the art. The junction box 16 may include control logic for supplying power to the controller 18 and to other vehicle electronics, such as electronics 30. The junction box 16 may also have logic for performing remote start and vehicle security functions.

The controller 18 may be microprocessor based such as a computer having a central processing unit, memory (RAM and/or ROM), and associated input and output buses. The controller 18 may be an application-specific integrated circuit or may be formed of other logic devices known in the art. The controller 18 may be a portion of a central vehicle main control unit, an interactive vehicle dynamics module, a main safety controller, or may be a stand-alone controller as shown. The controller 18 may perform as an engine controller and perform throttle control functions, crankshaft control functions, camshaft control functions, remote start functions, drive-by-wire functions, ignition system functions as well as other engine related and nonengine related functions.

The fuel control system 24 includes a throttle-controlled device 36, a throttle position sensor 37a fuel pump 38, and fuel injectors 40, as shown, as well as other fuel control system components known in the art. The throttle-controlled device 36 has various positions. In an embodiment of the present invention, the throttle-controlled device 36 has a default position that corresponds to a rest or unactuated position. The default position may be approximately 7-8° from a fully closed position. The throttle-controlled device 36 may also have a shutdown position referring to a temporary position that is held during engine shutdown. The shutdown position may be approximately 1.5° from the fully closed position. The default position may be electrically or mechanically controlled. The throttle-controlled device 36 may be of various types and styles known in the art. In an embodiment of the present invention the throttle-controlled device 36 is an electronically controlled throttle plate, which may be positioned at different angles within a throttle bore of a throttle body (both of which are not shown).

The vehicle electronics 30 may include vehicle lights, power windows and seat controls and motors, audio and video systems, air-conditioning systems, and other vehicle electronics or vehicle accessories known in the art.

The engine speed sensor 32 may be of various types and styles known in the art. The engine speed sensor 32 may be a camshaft rotational speed sensor, a crankshaft rotational speed sensor, or some other speed sensor known in the art.

An indicator 42 may be coupled to the controller 18 and indicate information pertaining to when a component is operating inappropriately or is inoperative. The indicator 42 may include a video system, an audio system, an LED, a light, a global positioning system, a heads-up display, a headlight, a taillight, a display system, a telematic system, or other indicator known in the art. The indicator 42 may even be a portion of a memory containing the stated information.

A safety monitor 43 may be coupled to or included within the controller 18. The safety monitor 43 may monitor circuit conditions for irregularities or irregular states. The controller 18 during shutdown may signal the safety monitor 43 that tasks being performed during shutdown and the states associated therewith are normal to prevent generation of a fault signal by the safety monitor.

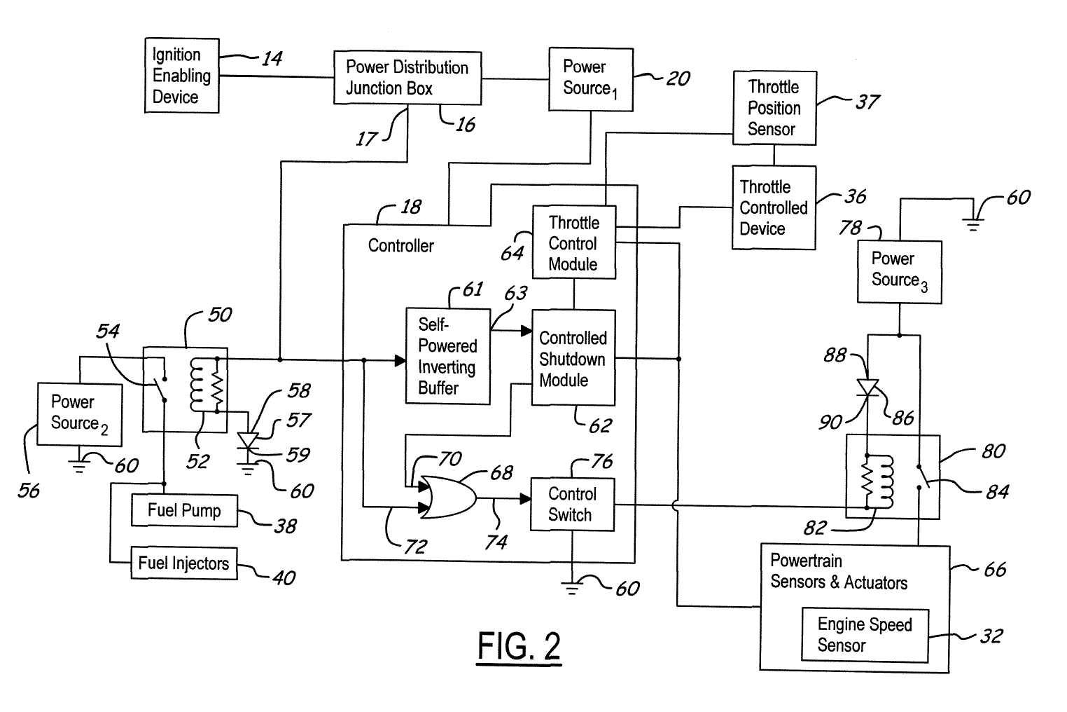

Referring now to FIG. 2, a schematic and block diagrammatic view of the shutdown system 10 in accordance with an embodiment of the present invention is shown. The junction box 16 is coupled to and generates a power signal that is received by a first relay 50 and by the controller 18. The first relay 50 has a first coil and resistor combination 52 and a first switch 54. In operation, the first coil combination 52 is activated by the power signal, which causes the first switch 54 to close. When the first switch 54 is in a closed position power from a second power source 56 is supplied to the fuel pump 38 and the fuel injectors 40. The first relay 50 may be of various types and styles and may supply power to various vehicle components depending upon the application.

The first coil combination 52 is coupled between the junction box output 17 and a first diode 57. The first diode 57 has an anode side 58 and a cathode side 59. The cathode side 59 is coupled to a ground 60. The first diode prevents reverse current from flowing between the first coil combination 52 and the ground 60.

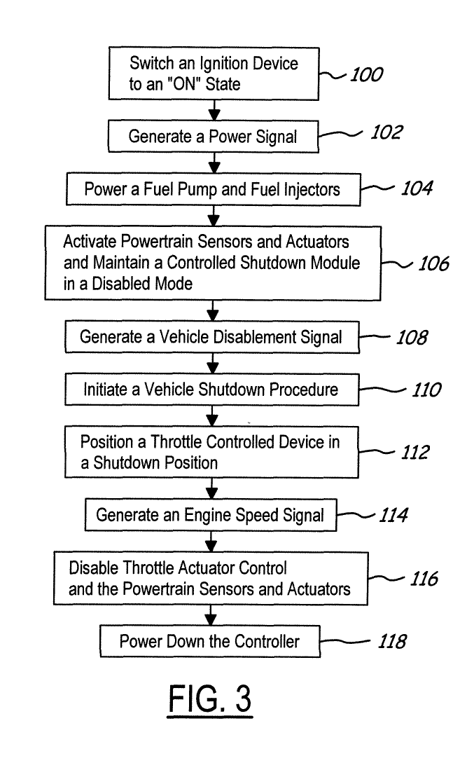

The controller 18 includes a self-powered inverting buffer 61 that is coupled to the junction box 16. The buffer inverts the power signal received by the junction box 16 before it is received by a controlled shutdown module 62. The shutdown module 62 receives the inverted power signal from a buffer output 63 of the buffer 61. The shutdown module 62 performs various vehicle controlled shutdown tasks. The tasks are further described in the method of FIG. 3.

The buffer 61 is self powered so that it is able to provide power to the shutdown module 62 when power is no longer received from the junction box 16, such as when the ignition device 14 is switched to the OFF state. The buffer 61 is also self-powered to isolate power received from the junction box 16 from power received by the shutdown module 62. Self-powering the buffer 61 prevents inadvertent or improper powering of the shutdown module 62. Various buffers may be used in replacement of or in combination with the buffer 61, as is known in the art.

The shutdown module 62, in one embodiment of the present invention, is software based. The shutdown module 62 signals a throttle control module 64 when power is no longer being received by the junction box 16 as part of a shutdown procedure. The shutdown module 62 also controls when power is no longer supplied to the power-train sensors and actuators 66, such as when the ignition device 14 is switched to the OFF state. The sensors and actuators 66 include the engine speed sensor 32 and may include various on-board diagnostics.

The throttle control module 64 controls actuation of the throttle-controlled device 36. The throttle control module 64 may also be software based. The tasks performed by the throttle control module 64 are also further described below with respect to the method of FIG. 3.

The controller 18 also includes a logic “OR” gate 68 having a first input 70, a second input 72, and an output 74. The first input 70 is coupled to the shutdown module 62 and the second input 72 is coupled to the junction box output 17. The OR output 74 is coupled to a control switch 76. The OR output 74 is in a high state when either the junction box output 17 or the power signal is in a high state or the voltage output of the shutdown module 62 is in a high state.

The control switch 76 allows current to pass from a third voltage source 78 through a second relay 80 to the ground 60. The second relay 80 includes a second coil resistor combination 82 and a second switch 84. When the OR gate output 74 is in a high state the second coil resistor combination 82 is activated and the second switch 84 is closed allowing power to be supplied from the third source 78 to the sensors and actuators 66. The control switch 76 may be of various types and styles known in the art. In one embodiment of the present invention the control switch 76 is a low side drive current regulator. The control switch 76 may have low voltage operation capability.

A second diode 86 is coupled between the third power source 78 and the second coil combination 82. The second diode 86 includes an anode 88 and a cathode 90. The second diode 86 prevents reverse current from flowing between the third power source 78 and the second coil combination 82. Both the first diode 57 and the second diode 86 may be in various locations.

The power sources 20, 56, and 78 may be of various types and styles known in the art. The power sources 20, 56, and 78 may be separate power sources, as shown, or may be a portion of or integrated into a single power source. The power sources 20, 56, and 78 may be in the form of a battery, a capacitor, or other form of power source known in the art.

Referring now to FIG. 3, a logic flow diagram illustrating a power cycle for the shutdown system 10 in accordance with an embodiment of the present invention is shown.

In step 100, the ignition device 14 is switched to an ON state. In step 102, the junction box 16 determines whether to generate a power signal in response to the ON state of the ignition device 14. The power signal may be generated in response to various remote start and security functions, as stated above. In one embodiment of the present invention when security parameters, such as a security code, have been satisfied the junction box 16 generates the power signal. The power signal may be in a digital format, such that when generated it is a five volt signal representing a logical one or high state.

In step 104, the first relay 50 and the controller 18 receive the power signal. The first switch 54 closes in response to the power signal and in turn causes power to be supplied from the second power source 56 to the fuel pump 38 and the fuel injectors 40.

In step 106, the sensors and actuators 66 are activated and the shutdown module 62 remains in a disabled mode. Since the junction box output 17 is at a high state, the buffer output 63 is at a low state and the OR gate output 74 is at a high state. The control switch 76 allows power to pass through the second relay 80 and activate the second switch 84 in response to the power signal.

In step 108, the ignition switch 14 is switched to the OFF state in effect generating a vehicle power down or disablement signal. The junction box in response to the disablement signal ceases generation of the power signal. Since the power signal is no longer generated, the fuel pump 38 and the fuel injectors 40 are disabled. On the other hand, power or an actuation signal is supplied from the buffer 61 to the shutdown module 62, since the state of the buffer output 63 is the inverse of the state of the junction box output 17. Thus, the shutdown module 62 is powered and temporary operation of a portion of the functions of the controller 18 is maintained when the ignition device 14 is switched to the OFF state.

In step 110, the high output state of the buffer 61 activates the shutdown module 62 to start a shutdown procedure in response to the disablement signal. The shutdown module 62 supplies a logical one to the OR gate 68 such that the OR gate output 74 remains in a high state. Since the OR gate output 74 remains in a high state the control switch 76 maintains power to the second relay 80. With the second relay 80 in an active state, speed of the engine 34 may be continuously monitored by the shutdown module 62 via the engine speed sensor 32.

The controller 18 may perform various tasks or functions during the shutdown procedure, such as an electronic throttle control function, a camshaft position function, a crankshaft position function, a remote start function, a drive-by-wire function, an ignition system function, and other functions known in the art. The controlled shutdown of the vehicle 12 by the controller 18 enables performance of these functions upon disabling of the ignition system 26 or switching of the ignition device 14 to the OFF state.

In step 112 of the embodiment illustrated by FIG. 3, the shutdown module 62 signals the throttle control module 64 to position the throttle-controlled device 36 to be in the shutdown position. The controller 18 may also adjust position of the throttle-controlled device 36 in response to a throttle position signal generated by the throttle position sensor 37. The shutdown position may be a predetermined position and may, for example, be approximately 1.5° from a fully closed position, as stated above. The shutdown position prevents noise and vibration generation during shutdown by decreasing the amount of air that may enter the engine 34 over that of the default position. The throttle-controlled device 36 remains in the shutdown position until speed of the engine 34 is approximately equal to zero.

In another example, the controller 18 performs an improved throttle learning closed in bore position function during the shutdown procedure. Position of the throttle-controlled device 36 may change over time due to component wear and other variables known in the art. Thus, position changes of the throttle-controlled device 36 are monitored over time. When position variations occur the controller 18 compensates for these variations by adjusting predetermined or actual positions of the throttle-controlled device 36. Having knowledge of these variations allows for improved and more accurate throttle actuator positioning.

In yet another example, the controller 18 again as part of the shutdown procedure may upon switching the ignition device 14 to the OFF state or during some moment in time soon thereafter ignite residual fuel remaining in the engine 34. The ignition of the residual fuel provides improved evaporative emissions and reduces hydrocarbons generated during “start-up” or when the ignition system 26 is reactivated.

Additionally, the controller 18 may record positions of the camshaft or the crankshaft, of the engine 34, during the shutdown procedure. Knowledge of engine positioning allows for more accurate control and efficient start-up of the engine 34. The controller 18 at start-up can better determine fuel supply amounts or flow rates and ignition timing for each of the cylinders. Accurate fuel supply and ignition timing provides efficient fueling and minimized generation of undesired emissions. Also, recordation of the engine positioning provides improved engine start consistency even when the vehicle operator releases the ignition device 14 quickly.

Furthermore, the controller 18 may record transmission gear settings during the shutdown procedure. In response to the transmission gear settings the controller 18 may prevent key removal unless the vehicle 12 is in a park mode, improving safety of the vehicle 12. This function may also further increase vehicle safety by preventing start of the engine 34 unless the transmission of the vehicle 12 is in a park or neutral gear.

In step 114, the engine speed sensor 32 generates an engine speed signal indicative of the speed of the engine 34. In step 116, the controller disables throttle actuator control and power to sensors and actuators 66. The throttle-controlled device 36 returns to the default position. The shutdown module 62 returns a first input 70 of the OR gate 68 to a low state when the engine speed signal is approximately equal to zero. The control switch 76 is deactivated in turn deactivating the second relay 80, opening the second switch 84, and disabling the sensors and actuators 66. In step 118, the controller 18 powers down.

The above-described steps are meant to be illustrative examples; the steps may be performed sequentially, synchronously, simultaneously, or in a different order depending upon the application. Also, the above-described states of the various components and systems are for example purposes, other states and state combinations may be utilized.

The present invention provides a controlled vehicle shutdown system and method of performing a vehicle shutdown, which enables performance of multiple shutdown tasks. The present invention prevents noise and vibration from occurring during a vehicle shutdown and can be used to improve fuel efficiency and to minimize vehicle emissions.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. a vehicle shutdown system comprising:
an ignition-enabling device having at least an ON state and an OFF state; and
an engine controller having a plurality of functions and being coupled to said ignition-enabling device, said engine controller at least temporarily maintaining operation of at least a portion of said controller functions when said ignition-enabling device is switched to said OFF state.

2. A system as in claim 1 wherein said plurality of functions are selected from at least one of an electronic throttle control function, a camshaft position function, a crankshaft position function, a remote start function, a drive-by-wire function, and an ignition system function.

3. A system as in claim 1 further comprising a throttle-controlled device, said engine controller electronically controlling said throttle-controlled device and at least temporarily preventing shutdown of electronic throttle control when said ignition-enabling device is switched to an OFF state.

4. A system as in claim 3 further comprising a switch coupled to said ignition-enabling device and a fuel supply system, said engine controller disabling said fuel supply system upon said ignition-enabling device being switched to said OFF state.

5. A system as in claim 3 further comprising a switch coupled to said engine controller, said engine controller enabling said switch when said ignition-enabling device is in said ON state and at least temporarily preventing disablement of said switch when said ignition-enabling device is in said OFF state.

6. A system as in claim 5 wherein said switch is a power relay.

7. A system as in claim 3 further comprising a throttle actuator position sensor generating a throttle position signal, said engine controller adjusting a position of said throttle-controlled device in response to said throttle position signal.

8. A system as in claim 3 wherein said ignition-enabling device is an ignition start key assembly.

9. A system as in claim 3 wherein said throttle-controlled device is a throttle plate.

10. A system as in claim 3 wherein said engine controller adjusts a position of said throttle-controlled device to be more air flow restrictive than that of said throttle-controlled device in a default position when said ignition-enabling device is switched to said OFF state.

11. A system as in claim 3 wherein said engine controller adjusts a position of said throttle-controlled device to be approximately 1.5° open relative to a closed position when said ignition-enabling device is switched to said OFF state.

12. A system as in claim 1 further comprising a safety monitor receiving an operation status signal from said engine controller when operation of said at least a portion of said controller functions is maintained and said ignition-enabling device is switched to said OFF state.

13. A system as in claim 1 wherein said engine controller is at least a portion of a drive-by-wire system controller.

14. A vehicle shutdown system comprising:
an ignition-enabling device having at least an ON state and an OFF state;
a throttle-controlled device; and
a controller coupled to said ignition-enabling device and electronically controlling said throttle-controlled device, said controller at least temporarily preventing shutdown of electronic throttle control when said ignition-enabling device is switched to said OFF state.

15. A method of powering down a vehicle having a controller with a plurality of functions comprising at least temporarily maintaining operation of at least a portion of said controller functions when said ignition-enabling device is switched to said OFF state.

16. A method as in claim 15 further comprising:
electronically controlling a throttle-controlled device;
and
at least temporarily preventing shutdown of electronic throttle control when said ignition-enabling device is switched to said OFF state.

17. A method as in claim 16 wherein at least temporarily preventing shutdown of electronic throttle control comprises:
adjusting a position of said throttle-controlled device to further restrict the flow of air over that of a default position when said ignition-enabling device is switched to said OFF state; and
enabling said throttle-controlled device to be in said default position when engine speed is approximately equal to zero.

18. A method as in claim 17 wherein enabling said throttle-controlled device to be in said default position comprises disabling said controller.

19. A method as in claim 17 wherein adjusting a position of said throttle-controlled device comprises adjusting said throttle-controlled device to be at approximately 1.5° from a closed position.

20. A method as in claim 16 further comprising enabling a power switch when said ignition-enabling device is in said ON state and temporarily preventing disablement of said power switch when said ignition-enabling device is in said OFF state.
